(19) United States
(12) Patent Application Publication
(10) Pub. No.: US 2008/0203199 A1
(43) Pub. Date: Aug. 28, 2008

(54) Processing of a guar dispersion for particle size reduction

(75) Inventors: Mark Serafin, Apple Valley, MN (US); Stanley R. Ellis, Mahtomedi, MN (US); Neal K. Nelson, Stillwater, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/703,489

(22) Filed: Feb. 7, 2007

(51) Int. Cl. B02C 19/06; B02C 23/00

(52) U.S. Cl. 241/5; 241/39

(57) ABSTRACT

A method includes processing a guar dispersion including guar particles and a fluid via an intensifier pump system and a fluid processing device that breaks up at least some of the guar particles to reduce an average particle size of the guar particles. The method may further include combining an aqueous fluid with the guar dispersion to hydrate the guar, mixing a proppant with the hydrated guar to produce a fracture fluid, and hydraulic fracturing a well using the fracture fluid. The invention may allow for reduced hydration time of guar particles in the guar dispersion.

### TECHNICAL FIELD

The invention relates to particle processing techniques, and more particularly, processing techniques for guar dispersions.

### BACKGROUND

Guar gum is hydrophilic polysaccharide derived from seeds of the guar plant. Common guar derivatives include hydroxyalkyl guar, carboxyalkyl guar, carboxyalkyl hydroxyalkyl guar, cationic guar, and hydrophobically modified guar. As used hereafter, the term guar includes guar gum and guar derivatives. Guar is a thickening agent in an aqueous solution such as brine. Guar can also be used as an emulsifier. Guar is utilized in a variety of industries including, for example, foods, textiles, pharmaceuticals, cosmetics and oil and gas recovery.

One manner in which guar is utilized for oil and gas recovery is in hydraulic fracturing. Hydraulic fracturing is routinely used in the oil and gas industry to improve or stimulate recovery of hydrocarbons, e.g., natural gas or oil, from underground formations. Hydraulic fracturing refers to forming a man-made fracture in an oil or gas reservoir rock by pumping a fracturing fluid down a well at high pressures for relatively short periods of time, e.g., on the order of a few hours. The pumping provides pressure that exceeds the strength of the rock, and causes fractures to open in the rock. A fracturing fluid includes a proppant such as sand and a carrier solution. The proppant is carried by the fracturing fluid and enters the fractures as they are formed. The proppant functions to keep the fractures from closing when the pumping pressure is released. The carrier solution contains additives, such as guar, to provide a viscosity sufficient to carry the proppant.

Fracturing fluids including a guar solution and a proppant are useful for hydraulic fracturing because guar may break down. This occurs under temperatures and pressures commonly present in a well. Over time in the well, the guar solution loses viscosity. This allows the guar solutions to be removed from fractures while leaving the proppant behind. Once the guar solution is removed, for example, hydrocarbons may be more easily removed from the rock.

### SUMMARY

In general, the invention is directed to techniques for processing a guar dispersion to reduce the maximum and/or average guar particle size, which, in turn, increases the hydration rate of the guar. A system breaks up guar particles in a guar dispersion using an intensifier pump system and a fluid processing device. In this manner, the system can reduce the average size of guar particles in a guar dispersion. For example, guar may be processed in a non-aqueous dispersion prior to hydration or in an aqueous dispersion prior to full hydration to increase the hydration rate. In another example, a non-aqueous guar dispersion may be combined with an aqueous fluid in the system to hydrate guar simultaneously while breaking up guar particles. The techniques provide an alternative to conventional guar processing techniques in which mechanical processes are used to process powdered guar prior to hydration.

In one embodiment, the invention provides a method comprising processing a guar dispersion including guar particles and a fluid via an intensifier pump system and a fluid processing device that breaks up at least some of the guar particles to reduce an average particle size of the guar particles.

In another embodiment, the invention provides a hydraulic fracturing system comprising a guar dispersion processing system that processes a guar dispersion including guar particles and a fluid to break up at least some the guar particles and outputs a product having a reduced average guar particle size, and a fracture pump that pumps a fracturing fluid including the product into a wellbore.

In another embodiment, the invention is directed to a guar dispersion comprising a non-aqueous fluid and guar particles dispersed in the non-aqueous fluid, wherein substantially all of the guar particles have a diameter less than approximately 70 microns.

The invention may provide one or more advantages. For example, the invention may reduce the average guar particle size of a guar dispersion, which increases hydration rate of the guar. In this manner, the techniques can reduce the time necessary to hydrate guar. With respect to hydraulic fracturing, this may reduce or eliminate the need for large hydration tanks necessary in the preparation of a fracturing fluid including guar.

Additional details of one or more embodiments are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary system that reduces guar particle size in a guar dispersion to increase the hydration rate of the guar prior to hydraulic fracturing.

FIG. 2 is a block diagram of an exemplary intensifier pump system that may be used to reduce guar particle size in a guar dispersion.

FIG. 3 is a cross-sectional side view of an exemplary fluid processing device that may be used to reduce guar particle size in a guar dispersion.

FIG. 4 is a cross-sectional side view of a portion of the fluid processing device shown in FIG. 3.

FIG. 5 is a block diagram of an exemplary system that reduces guar particle size in a guar dispersion to increase the hydration rate of the guar prior to hydraulic fracturing.

FIG. 6 is a cross-sectional side view of an exemplary fluid processing device that may be used to reduce guar particle size in a guar dispersion.

FIG. 7 is a flow diagram illustrating a technique to reduce guar particle size in a guar dispersion.

### DETAILED DESCRIPTION

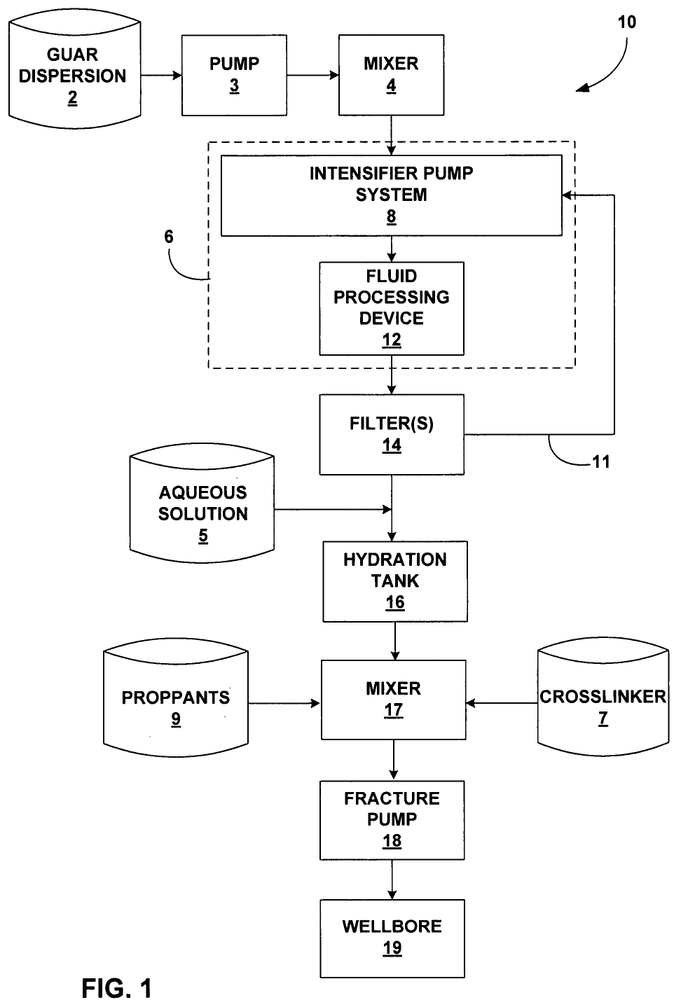

FIG. 1 is a block diagram of an exemplary system 10 that reduces guar particle size in a guar dispersion to increase the hydration rate of the guar. Guar gum is hydrophilic polysaccharide derived from seeds of the guar plant. As used hereafter, the term guar dispersion includes any dispersion with particles of guar and/or a guar derivative in a fluid. System 10 may incorporate a guar dispersion processing system 6, which breaks up at least some guar particles of the guar dispersion to reduce the maximum and/or average particle size in the guar dispersion. As described in greater detail below, solution processing system 6 may include an intensifier pump system 8, which uses two or more intensifier pumps that operate in a complementary fashion. In addition, guar dispersion processing system 6 may include a fluid processing device 12 with opposing annular flow paths, as further described herein.

As shown in FIG. 1, guar dispersion container 2 stores a guar dispersion. The dispersion stored in container 2 may comprise any dispersion including guar. Prior to the processing, some guar particles in the guar dispersion may have a diameter in excess of approximately 100 microns. As one example, following the processing described herein, the vast majority of guar particles (i.e., substantially all of the guar particles) may exhibit a diameter of less than approximately 70 microns. As other examples, the vast majority of guar particles may exhibit a diameter of less than approximately 65 microns, of less than approximately 60 microns, of less than approximately 50 microns, of less than approximately 40 microns, of less than approximately 30 microns, of less than approximately 20 microns, of less than approximately 10 microns, of less than approximately 5 microns, of less than approximately 1 micron, of less than approximately 0.5 microns, or even a diameter of less than approximately 0.1 microns. Producing dispersions with smaller guar particles may require that fluid processing device 12 includes flow paths with correspondingly smaller dimensions, that higher flow velocities be used, and/or that higher fluid pressures be used.

In different embodiments, for example, underivatized guar or derivatized guar can be used in the dispersion. Derivatized guars include, for example, hydroxyalkyl guar, carboxyalkyl guar, carboxyalkyl hydroxyalkyl guar, cationic guar, and hydrophobically modified guar. For example, the dispersion may comprise guar particles in a non-aqueous carrier fluid, such as oil. For example, mineral oil having a viscosity between approximately 100 centipoise (cP) to approximately 400 cP may be used as a carrier fluid. In one example, mineral oil having a viscosity of approximately 200 cP may be used as a carrier fluid.

One or more pumps 3 can serve to draw the guar dispersion from container 2 and deliver the guar dispersion to a mixer 4. Mixer 4 is an optional component. Mixer 4 receives the guar dispersion pumped from container 2 and mixes the guar dispersion, e.g., to achieve uniform distribution of the guar particles in the carrier fluid. Mixer 4 may comprise a high-shear mixer or the like, and is optional for system 10. Additional materials, such as additives or the like, may also be added in one or more stages using mixer 4 or additional mixers.

As mentioned above, system 10 includes a guar dispersion processing system 6, which breaks up at least some guar particles in the guar dispersion to reduce particle size. As shown in FIG. 1, guar dispersion processing system 6 may include an intensifier pump system 8, and a fluid processing device 12.

Intensifier pump system 8 may include one or more intensifier pumps, and may be capable of generating approximately 5,000 to 60,000 psi (34.5 MPa to 413 MPa) of fluid pressure. Fluid processing device 12, as described herein, may be capable of handling pressures greater than approximately 10,000 psi (68,950 kPa), greater than approximately 30,000 psi (207 MPa), greater than approximately 50,000 psi (345 MPa), or greater than approximately 60,000 psi (413 MPa). Following pressurization by intensifier pump system 8, the guar dispersion is delivered to fluid processing device 12. Fluid processing device 12 generates intense shear and extensional forces that reduces the size of the guar particles in the guar dispersion. In particular, fluid processing device 12 serves to break up any large guar particles of the guar dispersion into smaller-sized guar particles, and thereby produce a finely dispersed solution of guar particles in the processed guar dispersion having a more desirable size range. Heat exchangers (not shown) may be used to dissipate excess thermal energy generated during processing and generally control the temperature of the processed solution as desired. The shear and extensional forces are specifically useful in breaking up such large guar particles and may help to substantially eliminate any guar particles larger than approximately 70 microns.

One or more filters 14 may also be used to filter guar particles from the processed guar dispersion. For example, filters 14 may comprise one or more porous membranes, mesh screens, or the like, to filter the processed guar dispersion. Filters 14, however, are optional, and may be eliminated in some embodiments. In some cases, filtered portions of the processed guar dispersion (or, more generally, any unused portions of guar dispersion) may be recycled back to intensifier system 8 via a feedback loop 11. If desired, a back pressure regulator (not shown) may be added downstream of filters 14 to help maintain constant pressure in system 10 and provide a return path to supply guar dispersion container 2.

The output of filters 14 (or the output of fluid processing device 12 if filters 14 are not used) is combined with an aqueous fluid from aqueous fluid source 5 to hydrate the guar. In other embodiments, the dispersion in container 2 may comprise guar in an aqueous solution. In such embodiments, processing of the dispersion of the guar may speed the hydration rate of the guar in the aqueous solution of container 2 and aqueous fluid source 5 may not be necessary.

Optionally, the combined guar dispersion and aqueous fluid may be held in hydration tank 16. Hydration tank 16 is an optional component; in some embodiments, the guar may hydrate sufficiently without the need for hydration tank 16.

In some embodiments, the hydrated guar solution is crosslinked with crosslinker from crosslinker source 7 to generate desired levels of viscosity to carry proppants from proppants source 9. For example, the crosslinker may include borax, boric acid, antimony, or metal crosslinker selected from aluminum, zirconium or titanium compounds. In other embodiments, hydrated guar may not be crosslinked.

Proppants from proppants source 9 and crosslinker from crosslinker source 7 are added to the guar solution in mixer 17 to create the fracture fluid. Mixer 17 is an optional component. Mixer 17 may comprise a high-shear mixer or the like, and is optional for system 10. Additional materials, such as additives or the like, may also be added in one or more stages using mixer 17 or additional mixers.

Fracture fluid is pumped from mixer 17 to wellbore 19 by fracture pump 18. Fracture pump 18 provides a high pressure to open fractures in the rock of wellbore 19 to facilitate extraction of hydrocarbons from the rock.

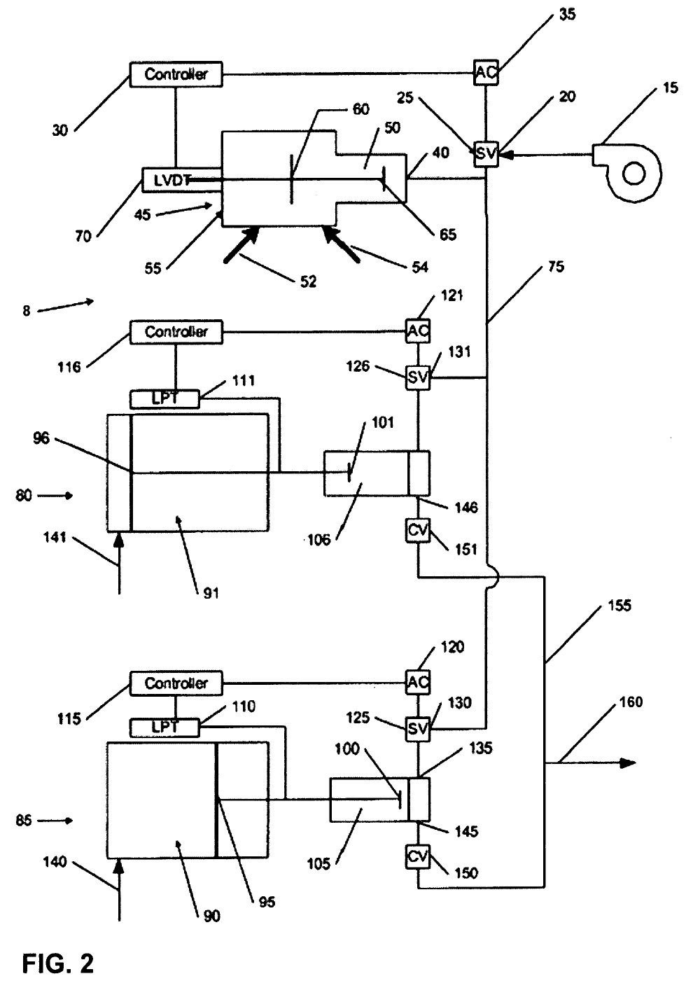

FIG. 2 is a diagram of an exemplary intensifier system 8 in accordance with an embodiment of the invention. Intensifier system 8 may be particularly useful in the delivery of a continuous, steady, high pressure flow of guar dispersion to fluid processing device 12. Typical fluid pressure may range from 0 psi to 40,000 psi (276,000 kilopascals), or greater, during each intensifier cycle. System 8 includes two different intensifier pumps 80 and 85 that operate in a complementary fashion to achieve the continuous, steady, high pressure flow of guar dispersion to fluid processing device 12. Additional intensifier pumps, however, could also be included in system 8. Also, a single intensifier pump could be used, but this embodiment might be less effective in achieving continuous, steady, high pressure.

Intensifier system 8 may be a hydraulic system that includes a low pressure supply pump 15. Supply pump 15 is used to deliver a guar dispersion into intensifier system 8 from a supply or reservoir (not shown in FIG. 2). Supply pump 15 may be a diaphragm pump, or other suitable pump, capable of delivering an appropriate volume of the guar dispersion. Supply pump 15 may deliver the guar dispersion at about 60-100 psi, although this can vary from system to system. Referring back to FIG. 1, in an alternative configuration, supply pump 15 (FIG. 2) could be used as pump 3 (FIG. 1) with intensifier system 8 (FIG. 1) including the remaining components of FIG. 2. In that case, mixer 4 (FIG. 1) could be eliminated, or possibly included after supply pump 15 (FIG. 2).

Referring again to FIG. 2, supply pump 15 feeds into inlet 20 of a check valve, hereinafter referred to as a “smart” valve 25. Smart valve 25 may comprise a controllable valve that can be actively opened and closed by a controller 30. Smart valve 25 may include a valve poppet (not shown) that is coupled to an actuator (not shown) that is in turn coupled to air cylinder 35. Air cylinder 35 (or another type of actuator) is controlled by controller 30 and can quickly and efficiently open or close smart valve 25 through the actuation of the valve poppet.

When smart valve 25 is opened, a guar dispersion is delivered through inlet/outlet 40 of a charge intensifier pump 45. More specifically, the guar dispersion is delivered into an intensifier barrel 50. Charge intensifier pump 45 includes a hydraulic actuator 55 having a hydraulic piston 60. As hydraulic piston 60 is caused to move back and forth, it causes product intensifier piston 65 to move back and forth as well. More specifically, as hydraulic piston 60 and product intensifier piston 65 retract, the guar dispersion is able to fill intensifier barrel 50. As hydraulic piston 60 advances, product intensifier piston 65 advances and the guar dispersion is expelled through inlet/outlet 40 at the appropriate intensified pressure. Hydraulic piston 60 is caused to advance by introducing hydraulic fluid under pressure through hydraulic fluid supply inlet (advance) 52 and retracted by introducing hydraulic fluid under pressure through hydraulic fluid supply inlet (retract) 54. An LVDT 70 (linear variable displacement transducer) or other type of position sensor can be coupled with hydraulic piston 60 so as to provide an indication of the piston's position to controller 30. Thus, controller 30 causes smart valve 25 to open when hydraulic piston 60 is ready to begin its retraction cycle.

Each time supply intensifier piston 65 advances, the guar dispersion is moved through inlet/outlet 40 at a relatively high pressure into supply line 75. While actual pressures will vary depending upon the configuration of the system, in one embodiment, the guar dispersion enters the supply line at between 700-2000 psi (4830-13,800 Kilo Pascals). The guar dispersion is then delivered to either a first product intensifier pump 80 or a second product intensifier pump 85 (each of which has the same components in the same configuration). It should be noted that more product intensifier pumps could be incorporated into the system and the illustrated embodiment having two such pumps is for illustrative purposes only. Also, in simpler embodiments, an intensifier system could include a single intensifier pump, although this would typically not provide continuous, steady, high pressure.

As illustrated in FIG. 2, first product intensifier pump 80 is in a retracted position when second product intensifier pump 85 is at or near the end of an extension cycle. In this manner, first and second product intensifier pumps 80, 85 operate at least partially out of phase with one another to provide a combined output that is substantially continuous and constant. Put another way, first and second product intensifier pumps 80, 85 operate in a complementary fashion, with one providing pressure intensification of a guar dispersion while the other re-fills with the guar dispersion.

Second product intensifier pump 85 includes a hydraulic actuator 90 having a hydraulic piston 95. Hydraulic piston 95 is coupled to a product intensifier piston 100 located within an intensifier barrel 105. A linear position transmitter (LPT) 110 is coupled between hydraulic piston 95 and a controller 115 so as to provide positional information to controller 115. Controller 115 may be coupled with an air cylinder 120 or other type of actuator that actuates smart valve 125.

As hydraulic piston 95 reaches the end of its extension cycle, information indicative of this position is sent by LPT 110 to controller 115. Controller 115 then causes smart valve 125 to open. The guar dispersion enters inlet 130 of smart valve 125, passes through and enters an inlet 135 of intensifier barrel 105. Because the guar dispersion may be delivered at pressures of about 1200 psi (8270 kilopascals) by charge intensifier pump 45, product intensifier piston 100 is forced backwards (in retraction) at a relatively high speed, also forcing hydraulic piston 95 to retract. This eliminates the need to provide a mechanism to hydraulically retract piston 95, such as a hydraulic fluid inlet. LPT 110 registers when hydraulic piston 95 has fully retracted and this data is passed to controller 115.

Charge intensifier pump 45 has a larger product displacement per stroke than that of second product intensifier pump 85. Thus, charge intensifier pump 45 fully fills intensifier barrel 105 with each stroke. Furthermore, charge intensifier pump 45 fills intensifier barrel 105 without introducing air, thus aiding in the control and elimination of pulsation. Controller 115 can be configured to not immediately close smart valve 125. Instead, smart valve 125 may remain open for a predetermined period of time to permit preloading. The guar dispersion continues to be delivered by charge intensifier pump 45, thus raising the pressure within intensifier barrel 105. In one embodiment, the pressure within intensifier barrel 105 is caused to increase to between 1600-1700 psi (11,000-11,700 kilopascals). At the appropriate time, controller 115 then causes smart valve 125 to close.

Hydraulic fluid supply 140 is then caused to deliver hydraulic fluid under pressure into hydraulic actuator 90. This, in turn, causes hydraulic piston 90 to advance, which causes product intensifier piston 100 to advance. Normally, there would be a pre-compression phase where the guar dispersion within intensifier barrel 105 is caused to increase in pressure before it is expelled. However, this phase can be greatly reduced or eliminated by bringing this guar dispersion to high pressure via the charge intensifier pump 45. Of course, the desired output pressure will be determinative of whether the pressures achieved by charge intensifier pump 45 are sufficient for preloading. As product intensifier piston 100 advances, it forces the guar dispersion through outlet 145 and causes check valve 150 to open. At the same time, smart valves 125, 126 prevent backflow of the guar dispersion through fluid line 75. The guar dispersion is then delivered, at pressure, to output line 155 where it becomes intensified product outflow 160. At this point, the guar dispersion advanced into fluid processing device 12, which is discussed in greater detail below. In one embodiment, product intensifier pumps 80, 85 can deliver the guar dispersion at pressures up to or exceeding 40,000 psi (276,000 kilopascals).

As product intensifier piston 100 reaches the end of its extension cycle, smart valve 125 is again opened and the process in repeated. Likewise, the same process occurs with first product intensifier pump 80. Specifically, like product intensifier pump 85, first product intensifier pump 80 includes a hydraulic actuator 91 having a hydraulic piston 96. Hydraulic piston 96 is coupled to a product intensifier piston 101 located within an intensifier barrel 106. A linear position transmitter (LPT) 111 is coupled between hydraulic piston 96 and a controller 116 so as to provide positional information to controller 116. LPT 111 may be located anywhere along hydraulic piston 96 or intensifier piston 101. Controller 116 is coupled with an air cylinder 121 that actuates smart valve 126.

As hydraulic piston 96 reaches the end of its extension cycle, information indicative of this position is sent by LPT 111 to controller 116. Controller 116 then causes smart valve 126 to open. The guar dispersion enters inlet 131 of smart valve 126, passes through and enters an inlet of intensifier barrel 106. Because the guar dispersion may be delivered at pressures of about 1200 psi (depending upon the actual configuration of the system) by charge intensifier pump 45, product intensifier piston 101 is rapidly forced backwards (in retraction), also forcing hydraulic piston 96 to retract. LPT 111 registers when hydraulic piston 96 has fully retracted and this data is passed to controller 115. This is the position illustrated in FIG. 2.

Hydraulic fluid supply 141 is then caused to deliver hydraulic fluid under pressure into hydraulic actuator 91. This, in turn, causes hydraulic piston 91 to advance which causes product intensifier piston 101 to advance. As product intensifier piston 101 advances, it forces the guar dispersion through outlet 146 and causes check valve 151 to open. The guar dispersion is then delivered, at pressure, to output line 155 where it becomes intensified product outflow 160. At this point, the guar dispersion is then delivered to fluid processing device 12. Thus, first product intensifier pump 80 and second product intensifier pump 85 are configured so that one is always delivering product while the other is retracting. In this manner, substantially consistent and uniform intensified product outflow 160 is achieved without significant pressure pulses.

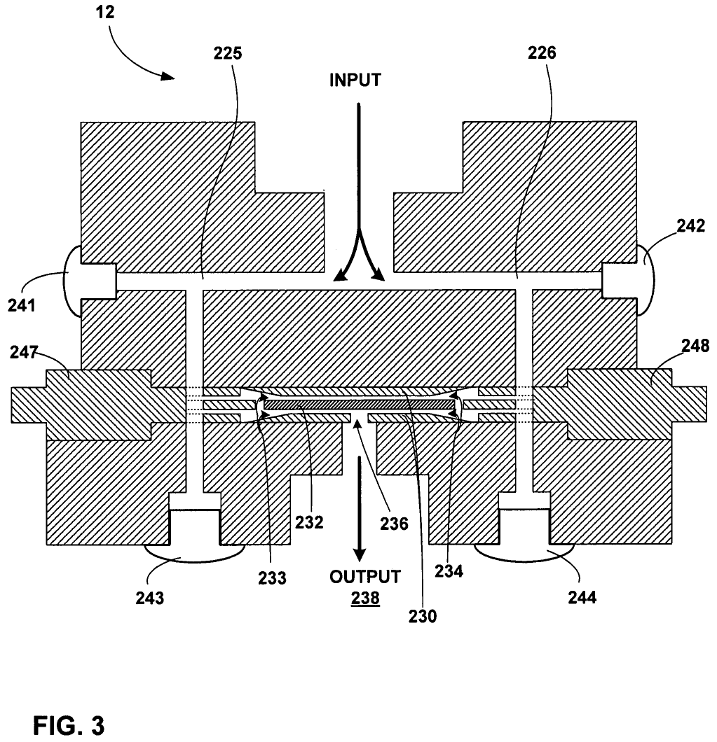

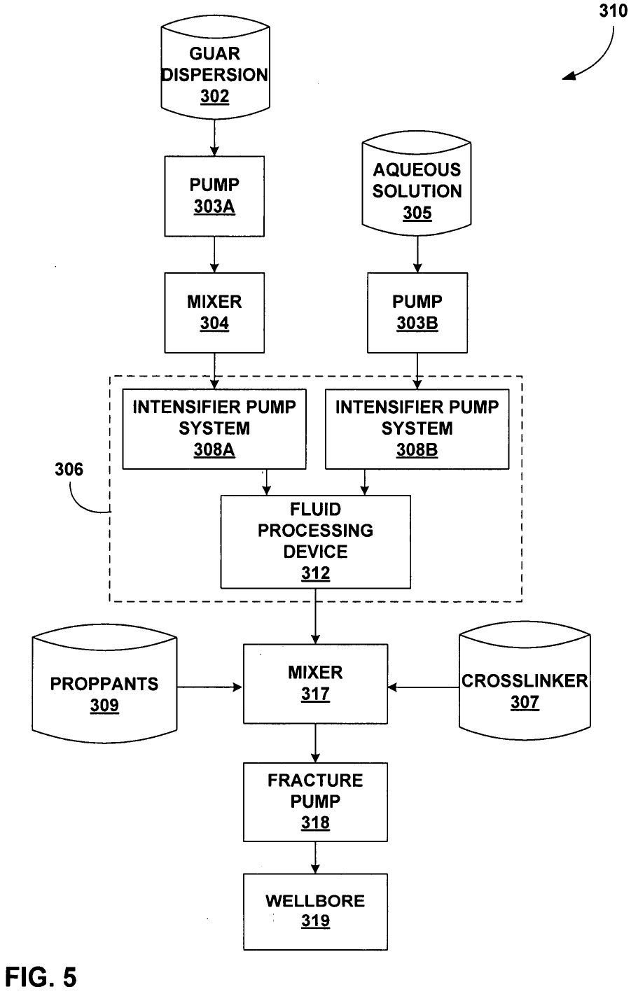

FIG. 3 is a cross-sectional view of an exemplary fluid processing device 12 suitable for use in guar dispersion processing system 6 of the larger system 10 described above. Fluid processing device 12 may be capable of handling pressures up to or greater than approximately 60,000 psi (413 MPa). As described herein, fluid processing device 12 receives a highly pressurized guar dispersion from intensifier system 8. The guar dispersion is separated into two separate initial flow paths 225, 226. Flow paths 225 and 226 feed into opposing sides of flow path cylinder 230, which defines annular flow paths. In other fluid processing devices, e.g., fluid processing device 312 (FIG. 5), flow paths similar to flow paths 225 and 226 may be supplied by separate fluid sources, e.g., guar dispersion 302 (FIG. 5) and aqueous fluid 315 (FIG. 5).

In fluid processing device 12, the inner diameter of flow path cylinder 230 defines an outer diameter of annular flow paths that feed toward one another to meet at the center of cylinder 230. Rod 232 is positioned inside flow path cylinder 230. For example, rod 232 may define first and second ends. A first end of rod 232 extends into annular flow path 233 and a second end of rod 232 extends into second annular flow path 234. The outer diameter of rod 232 defines the inner diameter of the annular flow paths. Accordingly, flow paths 225 and 226 respectively feed into annular flow paths 233, 234 defined by flow path cylinder 230 and rod 232.

The guar dispersion flows down annular flow paths 233, 234 and collides at or near outlet 236 formed in flow path cylinder 230, e.g., approximately at the lateral center of cylinder 230. The shear forces, extensional forces, and impact forces of the collision of the guar dispersion flowing down the annular flow paths 233, 234 causes guar particles in the guar dispersion to be broken into smaller, more desirable sized guar particles. Moreover, annular flow paths 233, 234 may enhance wall shear forces in fluid processing device 12 by increasing surface area associated with the flow paths. In this manner, fluid processing device 12 can be used to generate intense shear and extensional forces that act on the guar particles in a guar dispersion. After processing, the guar dispersion is expelled through outlet 236 and exits fluid processing device 12 (as indicated at output 238).

As further shown in FIG. 3, fluid processing device 12 may include pressure sensors 241, 242 to measure pressure within fluid processing device 12, as well as temperature sensors 243, 244 to measure the input temperature of the guar dispersion. A controller (not shown) may receive the pressure and temperature measurements, and adjust the pressure via one or more regulator valves (not shown) to maintain a desired pressure within fluid processing device 12. Similarly, one of the controllers associated with the intensifiers may receive temperature measurements, and cause adjustment of the temperature of the guar dispersion, as needed, to maintain a desired input temperature for the guar dispersion into fluid processing device 12. In particular, it is generally desirable to maintain substantially identical guar dispersion flows down the respective annular flow paths 233, 234 to ensure the desired impingement energy dissipation.

Substantially identical flows of the guar dispersion down the respective annular flow paths 233, 234, e.g., in terms of pressure or temperature, is indicative of a non-clogged condition. Temperature monitoring, in particular, can be used to identify when a clogged condition occurs, and may be used to identify when an anti-clogging measure should be taken, e.g., application of a pulsated short term pressure increase in the input flow to clear the clog.

Gland nuts 247, 248 may be used to secure flow path cylinder 230 in the proper location within fluid processing device 12. Moreover, gland nuts 247, 248 can be formed with channels (indicated by the dotted lines) that allow fluid to flow freely through flow paths 225, 226 and into annular flow paths 233, 234.

Rod 232 may be cylindrically shaped. However, other shapes of rod 232 may further enhance wall shear forces in the annular flow paths. Rod 232 may be free to move and vibrate within the flow path cylinder 230. In particular, rod 232 may be unsupported within flow path cylinder 230. Free movement of rod 232 relative to flow path cylinder 230 can provide an automatic anti-clogging mechanism to fluid processing device 12. If guar particles in the guar dispersion become clogged inside the fluid processing device 12, e.g., at the edges of annular flow paths 233, 234, rod 232 may respond to local pressure imbalances by moving or vibrating. In other words, a clog within cylinder 230 or in proximity of annular flow paths 233, 234 may result in a local pressure imbalance that causes rod 232 to move or vibrate. The movement and/or vibration of the rod 232, in turn, may help to clear the clog and return the pressure balance within fluid processing device 12. In this manner, allowing rod 232 to be free to move and vibrate within the flow path cylinder 230 can facilitate automatic clog removal.

To further improve clog removal, a pulsated short term pressure increase in the input flow can be performed upon identifying a clog. For example, as mentioned above, temperature sensors 243, 244 may identify temperature changes in flow paths 225, 226, which may be indicative of a clogged condition. In response, a short term pressure increase, e.g., a two-fold pressure increase for approximately five seconds, can cause more substantial movement and/or vibration of the rod 232 to facilitate clog removal. The pulsated short term pressure increase in the input flow can be performed in response to identifying a clogged condition, or on a periodic basis. For example, intensifier pump system 8 (FIG. 2) can be used to adjust the input pressure to fluid processing device 12. A short term pressure increase may be particularly useful in clearing clogs that affect both annular flow paths 233, 234. In that case, the temperature of both input flow paths may be similar, but may increase because of the clog that affects both annular flow paths 233, 234.

The components of fluid processing device 12, including flow path cylinder 230 and rod 232 may be formed of a hard durable material such as stainless steel or a carbide material. As one example, flow path cylinder 230 and rod 232 can be formed of tungsten carbide containing approximately six percent tungsten by weight. As another example, flow path cylinder 230 and rod 232 may comprise so-called “non-corroding” stainless steel that will not corrode in the presence of an aqueous guar dispersion, such as 316 or 304 stainless steel.

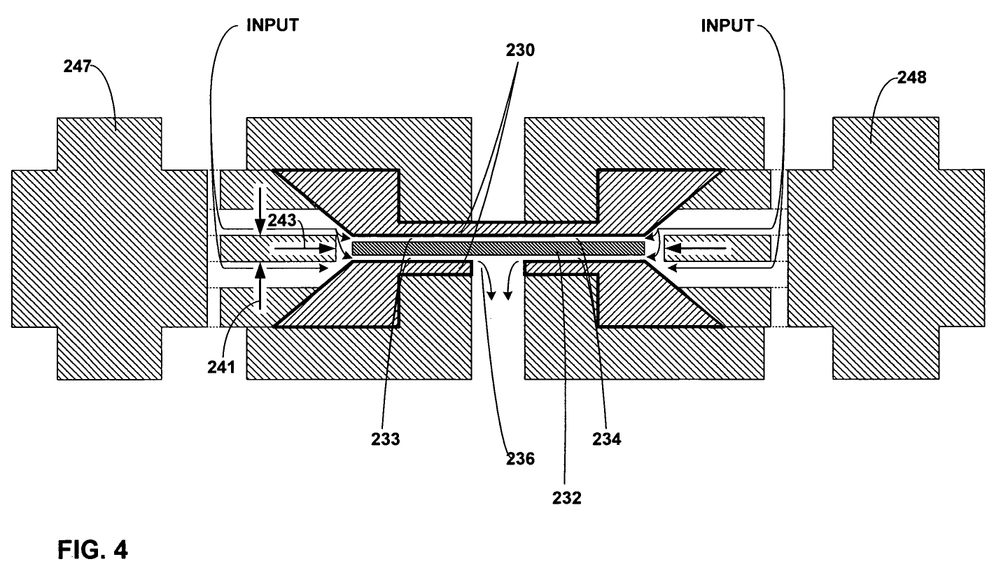

FIG. 4 is a cross-sectional side view of a portion of a fluid processing device 12 that incorporates annular flow paths. Gland nuts 247, 248 may be used to secure flow path cylinder 230 in the proper location within fluid processing device 12. Moreover, gland nuts 247, 248 can be formed with channels (indicated by the dotted lines) that allow fluid to flow freely into annular flow paths 233, 234. The ends of flow path cylinder 230 may be formed to mate with gland nuts 247, 248 in order to facilitate securing of cylinder 230 in a precise location.

Again, annular flow paths 233, 234 are defined by flow path cylinder 230 and rod 232. Flow path cylinder 230 may define a minimum width that remains substantially constant along the annular flow paths. Rod 232 may be cylindrically shaped, and can be free to move and vibrate within the flow path cylinder 230. Ordinarily rod 232 is concentric with the annular flow paths, having a center axis that is aligned with the central longitudinal axis of flow path cylinder 230. Fluid dynamic forces and uniform balance of rod 232 can force rod 232 toward the lateral and longitudinal center of the annular flow path. Movement and vibration of rod 232 within the flow path cylinder 230 can facilitate automatic clog removal.

The minimum width of the inner diameter of flow path cylinder 230 may be in the range of approximately 0.1 inch (0.254 cm) to 0.001 inch (0.00254 cm). For example, the width of the inner diameter of flow path cylinder 230 may be approximately 0.0290 inch (0.07366 cm). The width of the outer diameter of rod 232 may be slightly smaller than the minimum inner diameter of flow path cylinder 230. For example, if the width of the inner diameter of flow path cylinder 230 is approximately 0.0290 inch (0.07366 cm), the width of the outer diameter of rod 232 may be between approximately 0.0260 inch (0.06604 cm) and 0.0280 inch (0.07112 cm). Other sizes, widths and shapes of flow path cylinder 230 and rod 232 could also be used in accordance with the invention. The best size for a given application is dependent on, for example, the percent of solids of the guar dispersion being processed and the pressure and flow rate at which the guar dispersion is processed.

By way of example, the width of outlet 236 may be approximately between 0.0001 inch (0.000254 cm) and 0.1 inch (0.254 cm). As one example, the width of outlet 236 at the outer diameter of flow path cylinder 230 is approximately between 0.006 inch (0.01524 cm) and 0.010 inch (0.0254 cm). Outlet 236 may extend approximately 180 degrees around cylinder 230, or may extend to a lesser or greater extent, if desired. Other sizes and shapes of outlet 236 could also be used.

FIG. 5 is a block diagram of an exemplary system 310 that reduces guar particle size in a guar dispersion to increase the hydration rate of the guar prior to hydraulic fracturing. System 310 is similar to system 10 (FIG. 1). For brevity, some details of system 310 that have already been described with respect to system 10 are not described with respect to system 310. System 310 differs from system 10 in that system 310 combines a non-aqueous guar dispersion with an aqueous fluid within fluid processing device 312, whereas system 10 processes a guar dispersion prior to mixing it with an aqueous fluid.

System 310 may incorporate a guar dispersion processing system 306, which breaks up at least some guar particles of the guar dispersion to reduce the maximum particle size in the guar dispersion. Solution processing system 306 may includes intensifier pump systems 308A and 308B, which each use two or more intensifier pumps that operate in a complementary fashion. In addition, guar dispersion processing system 306 may include a fluid processing device 312 with opposing annular flow paths, as further described herein.

Guar dispersion container 302 stores a guar dispersion. Prior to the processing, some guar particles in the guar dispersion may have a diameter in excess of approximately 100 microns. Following the processing described herein, the vast majority of guar particles (i.e., substantially all of the guar particles) exhibit a diameter of less than approximately 70 microns.

One or more pumps 303A can serve to draw the guar dispersion from container 2 and deliver the guar dispersion to a mixer 304 and intensifier pump system 308A. Mixer 304 is an optional component. Likewise, one or more pumps 303B can serve to draw the aqueous fluid from aqueous fluid container 305 and deliver aqueous fluid to intensifier pump system 308B.

Intensifier pump systems 308A and 308B may each include one or more intensifier pumps, and may be capable of generating approximately 5,000 to 60,000 psi (34.5 MPa to 413 MPa) of fluid pressure. Fluid processing device 312, as described herein, may be capable of handling pressures greater than approximately 10,000 psi (68,950 kPa), greater than approximately 30,000 psi (207 MPa), greater than approximately 50,000 psi (345 MPa) or greater than approximately 60,000 psi (413 MPa). Following pressurization by intensifier pump systems 308A and 308B, the guar dispersion is delivered to one side of fluid processing device 312, while the aqueous fluid is delivered to the other side of fluid processing device 312. For example, fluid processing device 312 may be similar to fluid processing device 12 (FIG. 3 and FIG. 4).

Fluid processing device 312 generates intense shear and extensional forces that reduces the size of the guar particles in the guar dispersion. In particular, fluid processing device 312 serves to break up any large guar particles of the guar dispersion into smaller-sized guar particles, and thereby produce a finely dispersed solution of guar particles in the processed guar dispersion having a more desirable size range. Heat exchangers (not shown) may be used to dissipate excess thermal energy generated during processing and generally control the temperature of the processed solution as desired. The shear and extensional forces are specifically useful in breaking up such large guar particles and may help to substantially eliminate any guar particles larger than approximately 70 microns.

A hydrated guar solution is output of guar dispersion processing system 306 into mixer 317. In mixer 317, the hydrated guar solution is optionally crosslinked with crosslinker from crosslinker source 307 to generate desired levels of viscosity to carry proppants from proppants source 309. For example, the crosslinker may include borax, boric acid, antimony, or metal crosslinker selected from aluminum, zirconium or titanium compounds. In other embodiments, hydrated guar may not be crosslinked, in which case crosslinker source 307 can be eliminated.

Proppants from proppants source 309 and crosslinker from crosslinker source 307 are added to the guar solution in mixer 317 to create the fracture fluid. Mixer 317 is an optional component. Mixer 317 may comprise a high-shear mixer or the like, and is optional for system 10.

Fracture fluid is pumped from mixer 317 to wellbore 319 by fracture pump 318. Fracture pump 318 provides a high pressure to open fractures in the rock of wellbore 319 to facilitate extraction of hydrocarbons from the rock.

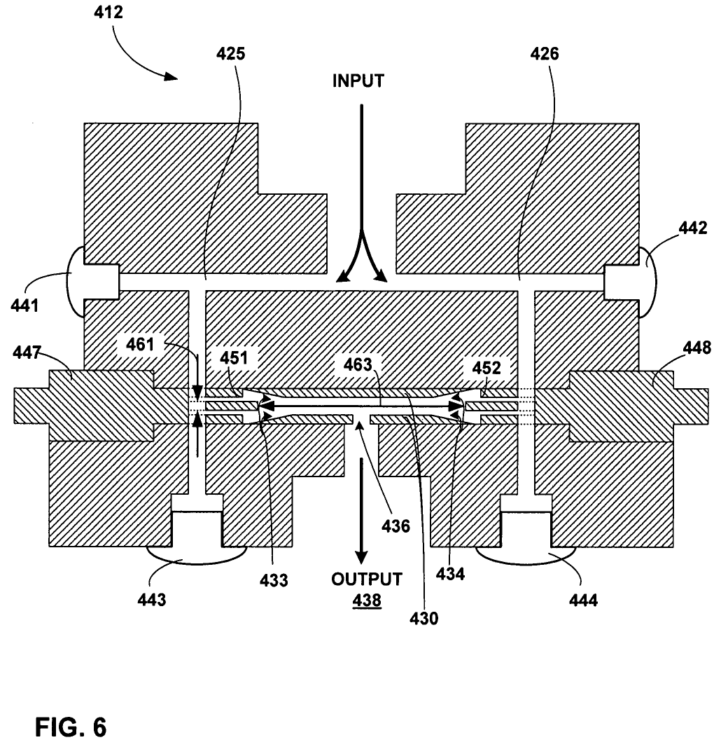

FIG. 6 is a cross-sectional view of an exemplary fluid processing device 412 which is a suitable alternative to fluid processing device 12 (FIG. 3 and FIG. 4) for use in guar dispersion processing system 6 of the larger system 10 described with respect to FIG. 1. Fluid processing device 412 is similar to fluid processing device 12 except that fluid processing device 412 does not include a rod between nozzles 451 and 452. For brevity, some details regarding fluid processing device 412 that have already been described with respect to fluid processing device 12 are not described again with respect to fluid processing device 412.

Fluid processing device 412 may be capable of handling pressures up to or greater than approximately 60,000 psi (413 MPa). As described herein, fluid processing device 412 receives a highly pressurized guar dispersion from intensifier system 8.

In fluid processing device 412, nozzles 451 and 452 direct fluid along flow paths 433 and 434 respectively. Inner diameter 461 of nozzles 451 and 452 and distance 463 between nozzles 451 and 452 may be selected to maximize shear forces from the impingement of fluid in flow paths 433 and 434. As one example, inner diameter 461 of nozzles 451 and 452 may be between approximately 0.01 inches and approximately 0.0001 inches. As another example, inner diameter 461 of nozzles 451 and 452 may be between approximately 0.005 inches and approximately 0.0003 inches. As another example, inner diameter 461 of nozzles 451 and 452 may be approximately 0.007 inches. The inner diameter of flow path cylinder 430 defines an outer diameter of flow paths that feed toward one another to meet at the center of cylinder 430. As examples, the gap 463 between nozzles 451 and 452 may be between approximately 0.1 inches and approximately 0.001 inches, and may also be between approximately 0.05 inches and approximately 0.005 inches. As one example, the gap 463 between nozzles 451 and 452 may be approximately 0.01 inches.

The guar dispersion flows down flow paths 433, 434 and collides at or near outlet 436 formed in flow path cylinder 430, e.g., approximately at the lateral center of cylinder 430. The shear forces, extensional forces, and impact forces of the collision of the guar dispersion flowing down the flow paths 433, 434 causes guar particles in the guar dispersion to be broken into smaller, more desirable sized guar particles. After processing, the guar dispersion is expelled through outlet 436 and exits fluid processing device 412 (as indicated at output 438).

Fluid processing device 412 may include pressure sensors 441, 442 to measure pressure within fluid processing device 412, as well as temperature sensors 443, 444 to measure the input temperature of the guar dispersion. A controller (not shown) may receive the pressure and temperature measurements, and adjust the pressure via one or more regulator valves (not shown) to maintain a desired pressure within fluid processing device 412. Similarly, one of the controllers associated with the intensifiers may receive temperature measurements, and cause adjustment of the temperature of the guar dispersion, as needed, to maintain a desired input temperature for the guar dispersion into fluid processing device 412. In particular, it is generally desirable to maintain substantially identical guar dispersion flows down the respective flow paths 433, 434 to ensure the desired impingement energy dissipation.

Substantially identical flows of the guar dispersion down the respective flow paths 433, 434, e.g., in terms of pressure or temperature, is indicative of a non-clogged condition. Temperature monitoring, in particular, can be used to identify when a clogged condition occurs, and may be used to identify when an anti-clogging measure should be taken, e.g., application of a pulsated short-term pressure increase in the input flow to clear the clog.

Gland nuts 447, 448 may be used to secure flow path cylinder 430 in the proper location within fluid processing device 412. Moreover, gland nuts 447, 448 can be formed with channels (indicated by the dotted lines) that allow fluid to flow freely through flow paths 425, 426 and into flow paths 433, 434.

To facilitate clog removal, a pulsated short term pressure increase in the input flow can be performed upon identifying a clog. For example, as mentioned above, temperature sensors 443, 444 may identify temperature changes in flow paths 425, 426 occur, which may be indicative of a clogged condition. In response, a short term pressure increase, e.g., a two-fold pressure increase for approximately five seconds can facilitate clog removal. The pulsated short term pressure increase in the input flow can be performed in response to identifying a clogged condition, or on a periodic basis. For example, intensifier pump system 8 (FIG. 2) can be used to adjust the input pressure to fluid processing device 412. A short term pressure increase may be particularly useful in clearing clogs that affect both flow paths 433, 434. In that case, the temperature of both input flow paths may be similar, but may increase because of the clog that affects both flow paths 433, 434.

The components of fluid processing device 412, including flow path cylinder 430, may be formed of a hard durable material such as stainless steel or a carbide material. As one example, flow path cylinder 430 can be formed of tungsten carbide containing approximately six percent tungsten by weight. As another example, flow path cylinder 430 may comprise so-called “non-corroding” stainless steel that will not corrode in the presence of an aqueous guar dispersion, such as 316 or 304 stainless steel.

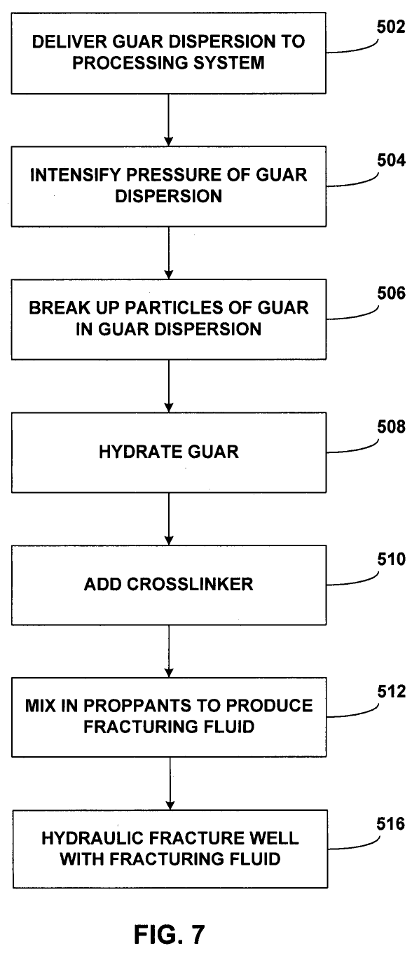

FIG. 7 is a flow diagram illustrating a technique to reduce guar particle size in a guar dispersion via an intensifier pump system and a fluid processing device that breaks up large guar particles in the guar dispersion in order to reduce the number and size of undesirable large guar particles. For clarity, the technique illustrated in FIG. 7 is described with respect to system 10 (FIG. 1). As shown in FIG. 7, pump 3 delivers a guar dispersion from container 2 to guar dispersion processing system 6 (502). Mixer 4 (shown in FIG. 1) is optional.

In guar dispersion processing system 6, intensifier system 8 intensifies the pressure of the guar dispersion (504). Fluid processing device 12 breaks up guar particles in the guar dispersion in order to reduce particle size (506), which can help reduce hydration time of guar in the guar dispersion. Following the processing by guar dispersion processing system 6, the processed guar dispersion is combined with an aqueous fluid to hydrate the guar (508).

The aqueous fluid used in hydration may include one or more surfactants and buffers. Additives such as salts, clay stabilizers, surfactants, emulsifiers and demulsifiers may be used and hydration can be in water or completion brines for the aqueous fluid. Completion brines are concentrated brines of salts such as ammonium chloride, sodium chloride, potassium chloride, sodium bromide, potassium bromide, calcium chloride, calcium bromide, zinc bromide or mixtures of the above.

Hydration may occur in optional hydration tank 16. For example, the guar may be hydrated by a period between approximately 5 seconds and 30 minutes. For example, the guar may be hydrated by a period between approximately 30 seconds and 20 minutes. For example, the guar may be hydrated by a period between approximately 30 seconds and 5 minutes. For example, the guar may be hydrated by a period between approximately 5 minutes and 10 minutes. In different examples, the guar may be hydrated by a period of approximately 20 minutes, a period of approximately 10 minutes, a period of approximately 5 minutes, a period of approximately 2 minutes, a period of approximately 1 minute, or a period of approximately 30 seconds. In systems without hydration tank 16, hydration may simply occur during the time the guar is transported between fluid processing device 12 and wellbore 19.

The hydrated guar solution is optionally crosslinked with a crosslinker (510). For example the crosslinker may be borax, boric acid, antimony, or metal crosslinker selected from aluminum, zirconium or titanium compounds or other crosslinker.

A proppant may be simultaneously or subsequently added to the hydrated guar solution with the optional crosslinker to produce a fracturing fluid (512). For example, the proppant may include sand or other proppant.

The fracturing fluid is then pumped into wellbore 19 at a pressure sufficient to hydraulically fracture the well (516). After pumping the fracturing fluid into wellbore 19, the guar may degrade and the carrier solution of the fracturing fluid may lose viscosity. The carrier solution of the fracturing fluid may then be pumped from wellbore 19 leaving the proppant behind to hold the fractures open.

### EXAMPLE

Experiment: A guar dispersion with a ratio of 500 grams of mineral oil having a viscosity of approximately 200 cP to 128.5 grams guar was processed using a fluid processing device similar fluid processing device 412 (FIG. 6). The inner diameter 461 of nozzles 451 and 452 was 0.007 inches and the gap 463 between nozzles 451 and 452 was 0.010 inches. An intensifier pump system was used to pump the guar dispersion through the fluid processing device at a pressure of 20,000 psi. The processed dispersion was allowed to cool for 10 minutes and was then reprocessed through the fluid processing device, again at a pressure of 20,000 psi.

Result: The process resulted in a reduction of maximum observed guar particle diameter from 184 microns to 63.3 microns. The minimum observed guar particle diameter remained constant at approximately 0.83 microns. The average observed guar particle diameter was reduced from 17.6 microns to 12.3 microns. The median observed guar particle diameter remained relatively constant with a slight increase from 7.70 microns to 7.78 microns. The root mean square (RMS) was reduced from 31.3 to 17.1. The standard deviation was reduced from 25.9 to 11.9. The variance was reduced from 668 to 140. The standard error was reduced from 1.76 to 0.711. The skewness was reduced from 3.21 to 1.72. Kurtosis was reduced from 12.5 to 2.95.

The experiment showed that the process reduces the size of the largest guar particles and had practically no effect on smaller guar particles. In effect, the process produced a more uniform guar dispersion. Kurtosis was reduced by a factor of four showing the process significantly reduces extreme variations in particle size. The reduction in skewness demonstrates an increase in the symmetry of the guar particle size distribution after processing.

A number of embodiments of the invention have been described. Nevertheless, it is understood that various modifications may be made without departing from the spirit and scope of the invention. For example, while processing techniques for reducing guar particle size in a dispersion were generally described with reference to making hydraulic fracturing fluids, the same techniques may be used to reduce guar particle size for other applications. Accordingly, such embodiments are within the scope of the following claims.

1. A method comprising processing a guar dispersion including guar particles and a fluid via an intensifier pump system and a fluid processing device that breaks up at least some of the guar particles to reduce an average particle size of the guar particles.

2. The method of claim 1, wherein the fluid is non-aqueous.

3. The method of claim 2, wherein the fluid is an oil.

4. The method of claim 3, wherein the oil has a viscosity between approximately 100 centipoise (cP) to approximately 400 cP.

5. The method of claim 1, further comprising adding a crosslinker to the guar dispersion following the processing.

6. The method of claim 5, wherein the crosslinker is selected from a group consisting of:
borax;
boric acid;
antimony;
aluminum;
zirconium; and
titanium.

7. The method of claim 1, further comprising mixing the guar dispersion with an aqueous fluid to hydrate the guar particles after processing the guar dispersion via the intensifier pump system and the fluid processing device.

8. The method of claim 1, further comprising reprocessing the guar dispersion via the intensifier pump system and the fluid processing device.

9. The method of claim 1, further comprising:
combining an aqueous fluid with the guar dispersion to hydrate the guar particles in the guar dispersion;
mixing a proppant with the hydrated guar particles to produce a fracture fluid; and
hydraulic fracturing a well using the fracture fluid.

10. The method of claim 1, wherein the intensifier pump system includes at least two hydraulic intensifier pumps, and wherein processing the guar dispersion includes operating the hydraulic intensifier pumps in a complementary fashion.

11. The method of claim 1, wherein the fluid processing device includes:
a first annular flow path for the guar dispersion;
a second annular flow path for the guar dispersion;
an outlet for the guar dispersion flowing within the first and second annular flow paths;
a flow path cylinder that defines an outer diameter of the first and second annular flow paths, the outlet being formed in the flow path cylinder; and
a cylindrical rod positioned within the flow path cylinder that defines an inner diameter of the first and second annular flow paths, wherein the cylindrical rod is not attached to any structure within the fluid processing device and is free to move under fluid dynamic force relative to the flow path cylinder.

12. A hydraulic fracturing system comprising:
a guar dispersion processing system that processes a guar dispersion including guar particles and a fluid to break up at least some the guar particles and outputs a product having a reduced average guar particle size; and
a fracture pump that pumps a fracturing fluid including the product into a wellbore.

13. The hydraulic fracturing system of claim 12, further comprising one or more mixers in which an aqueous fluid is combined with the product to hydrate the guar particles.

14. The hydraulic fracturing system of claim 13, wherein the fracturing fluid includes a proppant.

15. The hydraulic fracturing system of claim 12, wherein the guar dispersion processing system includes an intensifier pump system and a fluid processing device that breaks up at least some of the guar particles of the guar dispersion.

16. The hydraulic fracturing system of claim 15, wherein the intensifier pump system includes at least two hydraulic intensifier pumps that operate in a complementary fashion.

17. The hydraulic fracturing system of claim 16, wherein the fluid processing device includes:
a first annular flow path for the guar dispersion;
a second annular flow path for the guar dispersion;
an outlet for the guar dispersion flowing within the first and second annular flow paths;
a flow path cylinder that defines an outer diameter of the first and second annular flow paths, the outlet being formed in the flow path cylinder; and
a cylindrical rod positioned within the flow path cylinder that defines an inner diameter of the first and second annular flow paths, wherein the cylindrical rod is not attached to any structure within the fluid processing device and is free to move under fluid dynamic force relative to the flow path cylinder.

18. A guar dispersion comprising:
a non-aqueous fluid; and
guar particles dispersed in the non-aqueous fluid, wherein substantially all of the guar particles have a diameter less than approximately 70 microns.

19. The guar dispersion of claim 18, wherein the non-aqueous fluid is an oil.

20. The guar dispersion of claim 18, wherein substantially all of the guar particles have a diameter less than approximately 20 microns.
